(19) United States
(12) Patent Application Publication
(10) Pub. No.: US 2013/0233062 A1
(43) Pub. Date: Sep. 12, 2013

(54) FLUID ANALYSIS TOOL

(71) Applicant: Donald A. Funk, Saskatoon (CA)

(72) Inventor: Donald A. Funk, Saskatoon (CA)

(21) Appl. No.: 13/868,076

(22) Filed: Apr. 22, 2013

Related U.S. Application Data
(63) Continuation-in-part of application No. 12/923,774, filed on Oct. 7, 2010, now abandoned.

(51) Int. Cl. G01N 1/10

(52) U.S. Cl. CPC G01N 1/10
USPC 73/64.56

(57) ABSTRACT

An apparatus and method for analyzing a fluid wherein the apparatus comprises a transparent elongate body having a piston within a central cavity therein. The piston includes a first sealable chamber and defines a second chamber between the second end of the elongate body and the piston. The apparatus includes an opening through the second end of the elongate body and an actuator operably connected to the piston so as to draw the piston away from the opening so as to draw a second fluid into the second chamber. The method comprises introducing a volume of a control fluid into the first chamber and drawing the piston in a direction away from a second end of the elongate body so as to draw a volume of a sample fluid into the second chamber so as to permit visual comparison of the control and the sample fluids.

### CROSS REFERENCE TO RELATED APPLICATION

This application is a continuation-in-part of application Ser. No. 12/923,774 filed Oct. 7, 2010, entitled Fluid Analysis Tool, the entirety of which is hereby incorporated by reference.

### BACKGROUND OF THE INVENTION

1. Field of Invention

The present invention relates to fluid analysis in general and in particular to a method and apparatus for visually comparing two fluid samples.

2. Description of Related Art

In many applications, is desirable to analyze a fluid utilized during that process or by a particular machine. For example, in the field of automotive maintenance, it is necessary to check the condition of one or more of the fluids of the vehicle, including the oil, coolant, transmission fluid, brake fluid, differential or transfer fluid and power steering fluid. Proper monitoring and replacement of these fluids is an essential part of ensuring that the vehicle will last for the desired length of service of the vehicle.

Common conventional methods of testing fluid have been to utilize an electronic testing apparatus, with chemical reaction liquids or test strips, or a density measure among others. Such methods however are expensive and time consuming to perform. Typically consumers may not want to pay for the time and expense of having such a test performed. Additionally, many consumers may be less inclined to believe a test result that is given to them by a technician as they do not have the opportunity to perform the test themselves and see the test results. For such situations, it is often advantageous to be able to show the consumer the current appearance of the fluid.

Current methods of displaying fluids have been to pour the fluid in question into a container for viewing from the top and comparison with a reference chart. Such methods may not be satisfactory for all fluids, such as where one of the characteristics of the fluid to be assessed the opacity or degree of clarity. Additionally, the appearance, in particular color, may be affected by the color of the container into which the fluid is poured. The appearance of such characteristics may be adversely affected by the size, color, material or shape of the container into which the fluid is poured thereby adversely impairing the ability to compare the fluid to a reference picture which does not include these additional modifications due to the container.

Additionally, it may also be advantageous to compare the fluid being tested against a clean, or baseline fluid so as to show the change in appearance of the fluid from when it was new. Current methods of doing this have been to provide two containers which may hold the base and the sampled fluid wherein the two containers may then be visually compared to each other. Such methods may be messy due to pouring multiple fluids into containers. Such methods may also occupy an unnecessary amount of time.

### SUMMARY OF THE INVENTION

According to a first embodiment of the present invention there is disclosed an apparatus for analyzing a fluid comprising an elongate body extending between first and second ends, the elongate body having a central cavity therein and a piston sealably and slidably axially moveable within the central cavity, the piston having a first sealable chamber therein and defining a second chamber within the elongate body between the second end of the elongate body and the piston. The apparatus further comprises an opening through the second end of the elongate body in fluidic communication with the second chamber and an actuator operably connected to the piston so as to draw the piston away from the opening so as to draw a second fluid into the second chamber. At least a portion of the elongate body and the piston are transparent so as to permit a visual comparison of the second fluid and a first fluid contained within the first chamber.

The elongate body may include first and second end caps located at the first and second ends. The cylindrical member may extend along a central axis. The cylindrical body may be transparent. The cylindrical body may be formed of polyethylene terephthalate.

The first and second end caps may be formed of a metal. The first and second end caps may be threadably secured to the cylindrical member. The second end cap may include the opening therethrough.

The apparatus may further comprise a tube extending from the opening in fluidic communication therewith. The tube may be selectably connectable to the opening. The tube may be connectable to the opening by a tube connector.

The actuator may comprise a rod extending from the piston. The rod may extend axially along the central axis of the elongate body. The rod may extend through an end cap of the elongate body. The rod may include a handle at a distal end thereof.

The rod may be threadably received within an open end of a central cavity within the piston. The central cavity may define the first chamber. The rod may seal the open end of a blind bore within the piston. The rod may include a piston plug on the end thereof for engaging with and sealing the open end of the blind bore. The piston plug may be threadably received within the open end of the blind bore. The blind bore and piston plug may define the first chamber.

According to a further embodiment of the present invention there is disclosed a method for analyzing a fluid comprising introducing a volume of a control fluid into a first chamber within a piston slidably and sealably locating the piston axially within a chamber in an elongate body. The method further comprises drawing the piston in a direction away from a second end of the elongate body so as to draw a volume of a sample fluid into a second chamber of the elongate body between the piston and the second end through an opening therein and visually comparing the control and the sample fluids to each other.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of a fluid comparison apparatus according to a first embodiment of the present invention.

FIG. 2 is an exploded view of the fluid comparison apparatus of FIG. 1.

FIG. 3 is an exploded view of the piston of the fluid comparison apparatus of FIG. 1.

FIG. 4 is a cross-sectional view of the fluid comparison apparatus of FIG. 1 as taken along the line 3-3 with the piston at a first position.

FIG. 5 is a cross-sectional view of the fluid comparison apparatus of FIG. 1 as taken along the line 3-3 with the piston at a second position.

FIG. 6A is a detailed view of a quick release coupler of the apparatus of FIG. 1 at a locked position according to a further embodiment of the present invention.

FIG. 6B is a detailed view of a quick release coupler of the apparatus of FIG. 1 at a release position according to a further embodiment of the present invention.

### DETAILED DESCRIPTION

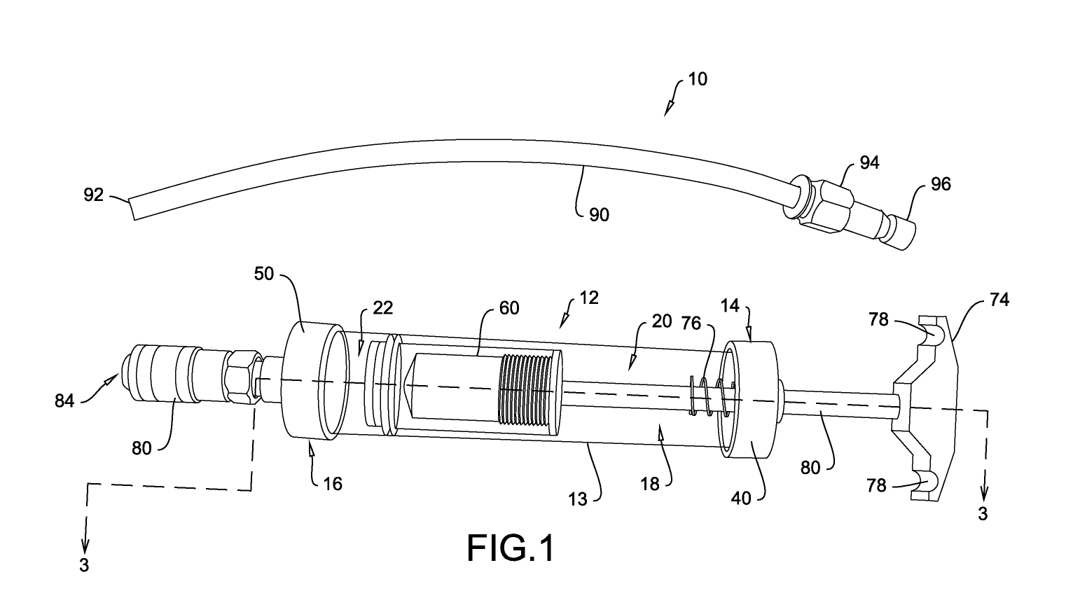

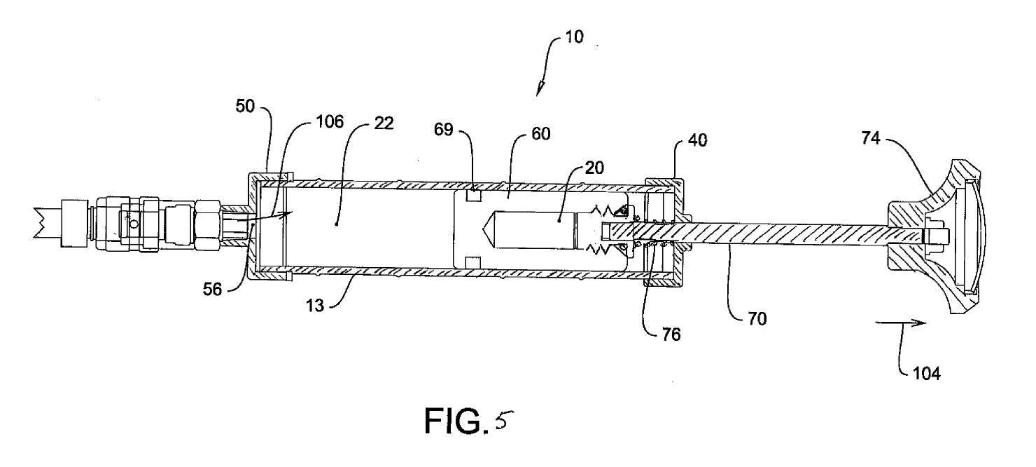

Referring to FIGS. 1 through 5, an apparatus for analysing a fluid according to a first embodiment of the invention is shown generally at 10. The apparatus 10 comprises an elongate cylindrical body 12 comprising a tube 13, extending between first and second ends 14 and 16, respectively and having a cavity 18 therein and a piston 60 slidably and sealably received within the cavity. The piston 60 includes a first chamber 20 therein and defines a second chamber 22 within the cavity 18. The apparatus 10 further includes first and second end caps, 40 and 50, respectively, enclosing the first and second chambers 20 and 22 and a pick-up tube 90 extending from the second end cap 50

Each of the first and second ends 14 and 16 may include exterior threading, 24 and 26, respectively, for securing the first and second end caps 40 and 50 thereto as will be further explained below. The tube 13 includes a central bore 28 extending therethrough along a central axis sized to receive the piston 60 therein. As illustrated and described above, the tube 13 may be cylindrical, although it will be appreciated that other cross-sectional shapes may be useful as well, such as, by way of non-limiting example, triangular, square, octagonal, oval, or irregular provided the piston 60 is sized and shaped to be sealably received therein so as to prevent mixing of the fluids contained in each of the first and second chambers. The tube 13 may be formed of any suitable material selected to be substantially transparent. Optionally the tube 13 may be formed to have a transparent portion so as to permit observation of the contents of the apparatus. In particular, the tube may be formed of any suitable transparent material which is impact resistant and chemically neutral with common automotive fluids, such as by way of non-limiting example co-polymerized polyethylene terephthalate (PETG).

The first end cap 40 includes a disk portion 41 and a sleeve portion 43 at a distal edge thereof. The first end cap 40 encloses the first end 14 of the tube 13 within an interior thereof. Optionally, the first end cap 40 may include interior threading 42 adapted to engage with the exterior threading 24 on the first end 14 of the tube 13 although other means for securing the end caps to the tube may be utilized as well. In this way, the first end cap 40 may be threadably secured onto the first end 14 of the tube 13. The first end cap 40 also includes an extension 44 extending axially from the disk portion 41. The extension 44 includes a bore 46 therethrough sized to pass a rod as will be further described below.

The second end cap 50 includes a disk portion 51 and a sleeve portion 53 at a distal edge thereof. The second end cap 50 encloses the second end 16 of the tube 13 within an interior thereof. Optionally, the second end cap 50 may include interior threading 52 adapted to engage with the exterior threading 26 on the second end 16 of the tube 13 although other means for securing the end caps to the tube may be utilized as well. In this way, the second end cap 50 may be threadably secured onto the second end 16 of the tube 13. The first end cap 50 also includes an extension 54 extending axially from the disk portion 51. The extension 54 includes a threaded bore 56 therethrough to receive a drawing tube connection as will be more fully described below. The threaded bore 56 also maintains the second chamber 22 which is adjacent to the second end cap 50 in fluidic communication with the drawing tube connection. The first and second end caps may be formed of any suitable material such as steel, brass, copper, stainless steel, plastics, ceramics or any other suitable material.

The piston 60 comprises an elongate tubular member extending between first and second ends, 62 and 64, respectively and has an exterior surface 66. The exterior surface 66 is sized and shaped to closely correspond to the central bore 28 of the tube 13. The exterior surface 66 also includes a groove 67 therearound adapted to receive an o-ring 69 or other suitable seal therein.

The o-ring 69 seals the space between the piston 60 and the tube 13 so as to sealably isolate the second chamber 22.

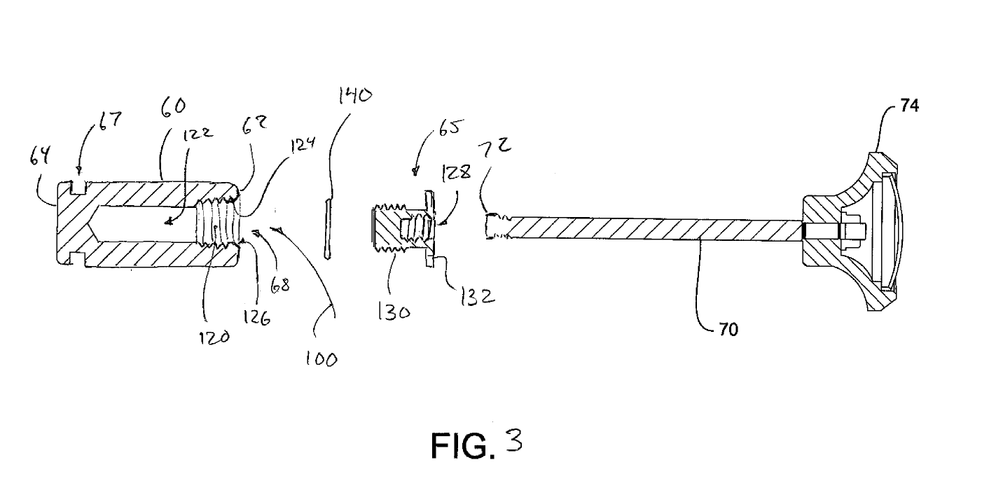

As illustrated in FIG. 3, the piston includes a piston bore 68 formed therein extending from the second end 64 of the piston. The piston bore includes an open end or section 120 and an unobstructed portion 122. The piston bore 68 threadably and sealably receives an actuator rod 70 therein so as to enclose and seal the first chamber 20. The actuator rod 70 may optionally include a piston plug 65 on a distal end thereof which is received within open end 120 of the piston bore 68. With reference to FIG. 3, the open end 120 of the piston includes internal threading 124 therein and a chamfered entrance 126. The piston plug 65 includes a threaded portion 130 corresponding to the internal threading 124 of the piston. The piston plug includes a top flange 132 adapted to bear against the first end 62 of the piston 60. A seal 140, such as, by way of non-limiting example, an 0-ring is provided to be located between the first end 62 of the piston 60 and the top flange 132 of the piston plug 65. As the piston plug 65 is tightened into the piston bore 68, the o ring 140 is compressed between the top flange 132 and the first end 62 of the piston 60 so as to seal the first chamber 20 within the piston. It will be appreciated that the chamfered entrance 126 assists in providing such seal by compressing the o-ring 140 against both the top flange 132 and the threaded portion 130 of the piston plug 65 as well as against the chamfered entrance 126 of the piston. After locating the rod 70 or the piston plug 65 within the open end 120, the unobstructed portion 122 will be isolated from the exterior of the piston such that any fluid introduced into the first chamber 20 will be isolated from any other fluids introduced to the apparatus as discussed further below. The piston 60 may be similarly formed of transparent materials as the tube 13.

As set out above, the first chamber 20 is formed within the piston 60 and is defined by the piston bore 68 as sealed by the piston plug 65. The second chamber 22 is formed between second end 64 of the piston and the second end cap 50.

The apparatus 10 further includes an actuator which, as illustrated in the accompanying figures may comprise a rod 70. The rod 70 has a diameter selected to be received within the bore 46 of the first end cap 40 and form a seal therebetween so as to seal the first chamber 20. The rod 70 includes a first threaded end 72 and a handle 74 at a second end. The rod 70 also includes a compression rod spring 76 located therearound, the purpose of which will be described below. The handle 74 may comprise a finger grip style handle as illustrated in FIG. 1 having finger grip locations 78.

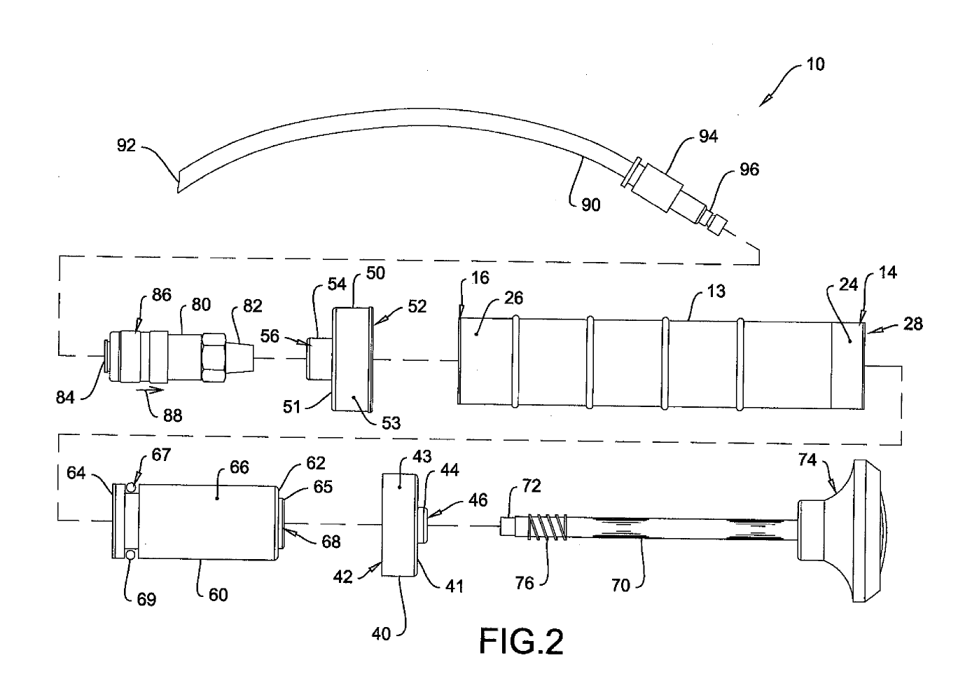

Optionally, the handle may comprise a circular knob-type handle as illustrated in FIG. 2-5 or any other suitable handle type as will be appreciated.

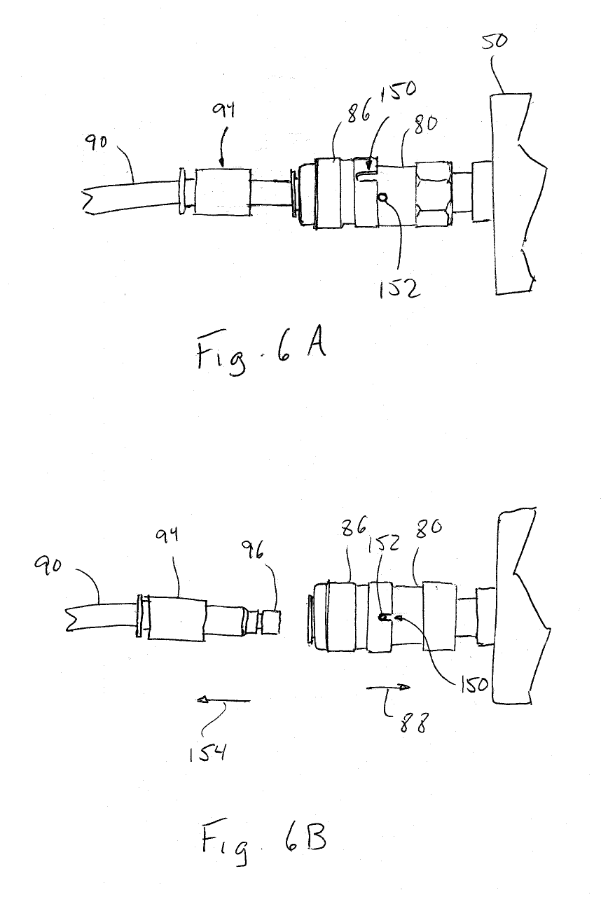

The second end cap 50 includes a quick release coupler 80 connected thereto as are commonly known. The quick release coupler 80 includes a threaded end 82 and an open end 84. The open end 84 includes a quick release ring 86 which may be pulled backwards in a direction generally indicated at 88 to release or attach a corresponding coupler connected to the pick-up tube 90 as will be explained below. The quick release coupler 80 includes a bore therethrough (not shown) so as to maintain the second chamber 22 in fluidic communication with the pick-up tube 90 when attached. The quick release coupler 80 may optionally be valved so as to close and seal the second chamber 22 from the outside environment when a pick-up tube 90 is not connected thereto as are commonly known. As illustrated in FIGS. 6A and 6B, the quick release coupler 80 may include a slot 150 extending into the quick release ring 86 from the edge closest to the second end cap 50. The quick release coupler 80 may further include a pin or protrusion 152 extending from therefrom which is sized to be slidably located within the slot 150. The pin 152 is positioned to prevent movement of the quick release ring 86 during normal operation by abutting against the edge closest to the second end cap 50 as illustrated in FIG. 6A. When a user desires to release the pick-up tube 90 from the quick coupler, the quick release ring 86 may be rotated to align the slot 150 with the pin and thereafter retracted in the direction generally indicated at 88. Thereafter the pick-up tube 90 may be removed therefrom in the direction generally indicated at 154.

The pick-up tube 90 comprises an elongate tube having an open end 92 and a connection end 94. The connection end 94 includes a quick connection plug 96 operable to cooperate with the quick connection socket of the quick release coupler 80 to be interconnected therewith. The pick-up tube 90 may have a length selected according to the desired application. By way of non-limiting example, the pick-up tube 90 may have a length between of 6 and 48 inches (152 and 1219 mm) although it will be appreciated that different lengths may be useful for use with different fluids and automotive types. It will be appreciated that other ranges may be useful as well depending upon the application and the distance between a fluid source and the availability of user access thereto. It will also be appreciated that the use of a quick-connect style coupler as described above will facilitate the use of pick-up tubes 90 of differing lengths. The pick-up tube 90 may be formed of any suitable material such as natural or synthetic rubber, silicone, plastics such as polyethylene or polystyrene, and may optionally be flexible so as to facilitate introduction of the pick-up tube 90 into a variety of fluid sources.

The apparatus 10 is assembled by passing the tube 90 through the bore in the first end cap and threadably securing the threaded end 72 into the piston bore 68 such that the rod spring 76 is between the piston and the first end cap. The piston 60 may then be located within the central bore 28 of the tube 13. The second end cap 50 may be threadably secured onto the second end 16 of the tube 13 and the threaded end 82 of the quick release coupler 80 threadably secured into the threaded bore 56 of the second end cap 50.

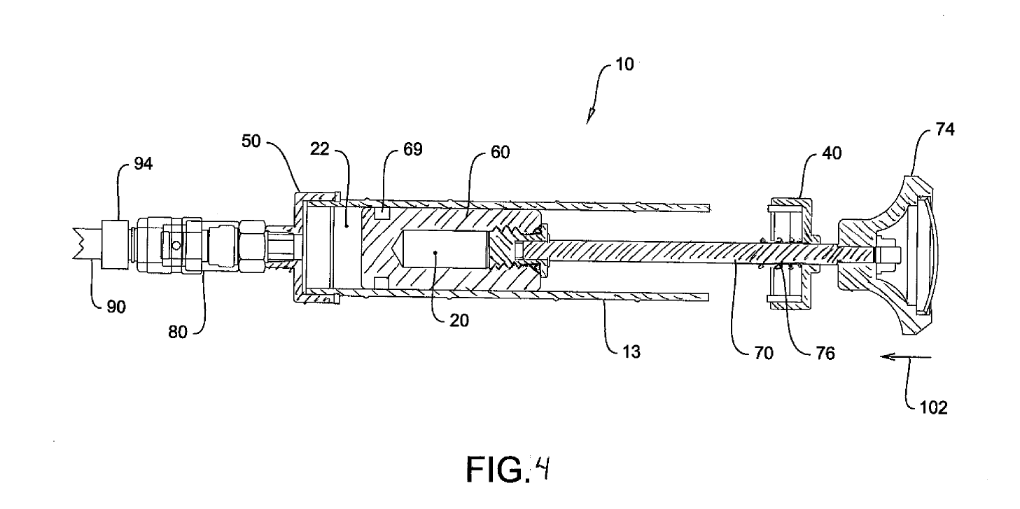

With reference to FIGS. 3 and 4, in operation, a sample of a reference fluid may be introduced by pouring or otherwise into the open first piston bore 68 of the piston 60 in a direction generally indicated at 100. The piston plug 65 may then be secured within the piston bore 68 with the o-ring 140 therebetween so as to seal the reference fluid within the first chamber. Thereafter the rod 70 may be passed through the first end cap 40 and secured within internal threading 128 of the piston plug. After sealing the reference fluid within the piston, the piston 60 may then be located within the cavity 18 of the elongate cylindrical body 12 to a position adjacent to the second end cap 50 by pushing the handle 74 towards the second end cap 50 in a direction generally indicated at 102 and the first end cap 40 threaded onto the first end 14 of the cylindrical body.

To test a sample, the quick connection plug 96 may be secured within the quick release coupler 80 so as to attach a pick-up tube 90 to the cylindrical body 12 and second end cap 50. The open end 92 of the pick-up tube 90 may then be inserted into a fluid reservoir (not shown) of the fluid to be tested and the handle 74 drawn away from the second end cap 50 in a direction generally indicated at 104 so as to draw the sample fluid into the second chamber 22 through the pick-up tube 90. Thereafter the apparatus may be held up for visual inspection by a user so as to compare the appearance of the reference fluid in the first chamber 20 and the sample fluid in the second chamber 22. By way of non-limiting example the color of each fluid may be compared to each other, the clarity of each fluid may be compared to each other or the thickness or viscosity of each fluid may be compared to each other by moving the apparatus to observe the relative movement of each fluid therein. During and after the process of drawing the sample fluid into the second chamber 22, the rod spring 76 serves as a cushion between the piston 60 and the first end cap 40.

While specific embodiments of the invention have been described and illustrated, such embodiments should be considered illustrative of the invention only and not as limiting the invention as construed in accordance with the accompanying claims.

What is claimed is:

1. An apparatus for analyzing a fluid comprising:
an elongate body extending between first and second ends, said elongate body having a central cavity therein;
a piston sealably and slidably axially moveable within said central cavity, said piston having a first sealable chamber therein and defining a second chamber within said elongate body between said second end of said elongate body and said piston;
an opening through said second end of said elongate body in fluidic communication with said second chamber; and
an actuator operably connected to said piston so as to draw said piston away from said opening so as to draw a second fluid into said second chamber,
wherein at least a portion of said elongate body and said piston are transparent so as to permit a visual comparison of said second fluid and a first fluid contained within said first chamber.

2. The apparatus of claim 1 wherein said elongate body includes first and second end caps located at said first and second ends.

3. The apparatus of claim 2 wherein said cylindrical member extends along a central axis.

4. The apparatus of claim 2 wherein said cylindrical member is transparent.

5. The apparatus of claim 4 wherein said cylindrical member is formed of polyethylene terephthalate.

6. The apparatus of claim 2 wherein said first and second end caps are formed of a metal.

7. The apparatus of claim 6 wherein said first and second end caps threadably secured to said cylindrical member.

8. The apparatus of claim 2 wherein said second end cap includes said opening therethrough.

9. The apparatus of claim 1 further comprising a tube extending from said opening in fluidic communication therewith.

10. The apparatus of claim 9 wherein said tube is selectably connectable to said opening.

11. The apparatus of claim 10 wherein said tube is connectable to said opening by a tube connector.

12. The apparatus of claim 1 wherein said actuator comprise a rod extending from said piston.

13. The apparatus of claim 12 wherein said rod extends axially along said central axis of the elongate body.

14. The apparatus of claim 12 wherein said rod extends through an end cap of said elongate body.

15. The apparatus of claim 12 wherein said rod includes a handle at a distal end thereof.

16. The apparatus of claim 12 wherein said rod operably seals an open end of a blind bore within said piston.

17. The apparatus of claim 16 wherein said rod includes a piston plug on the end thereof for engaging with and sealing said open end of said blind bore.

18. The apparatus of claim 17 wherein said piston plug is threadably received within said open end of said blind bore.

19. The apparatus of claim 17 wherein said blind bore and said piston plug defines said first chamber.

20. A method for analyzing a fluid comprising:
introducing a volume of a control fluid into a first chamber within a piston;
slidably and sealably locating said piston axially within a chamber in an elongate body;
drawing said piston in a direction away from a second end of said elongate body so as to draw a volume of a sample fluid into a second chamber of said elongate body between said piston and said second end through an opening therein; and
visually comparing said control and said sample fluids to each other.
